(19) United States
(12) Patent Application Publication
(10) Pub. No.: US 2023/0422123 A1
(43) Pub. Date: Dec. 28, 2023

(54) METHODS AND APPARATUS TO IMPROVE UE EXPERIENCE WITH A NEW TYPE OF RADIO BEARER DURING INTER-DU INTER-CELL BEAM MANAGEMENT

(71) Applicant: MediaTek Singapore Pte. Ltd., Singapore (SG)

(72) Inventors: Yuanyuan Zhang, Beijing (CN); Xiaonan Zhang, Beijing (CN)

(21) Appl. No.: 18/447,931

(22) Filed: Aug. 10, 2023

Related U.S. Application Data
(63) Continuation of application No. PCT/CN2022/101936, filed on Jun. 28, 2022.

(30) Foreign Application Priority Data
Jun. 28, 2022 (WO) PCT/CN2022/101936
Jun. 12, 2023 (CN) 202310693410.8

(51) Int. Cl. H04W 36/08; H04W 36/00

(52) U.S. Cl. CPC H04W 36/08; H04W 36/0016

(57) ABSTRACT

Apparatus and methods are provided for L1/L2-triggered mobility (LTM) cell switch. In one novel aspect, the UE performs an LTM handover by selecting and using the best beam taking advantage of the ping-pong effect of frequent cell switches for intra-CU with inter-DU and intra-DU cell switches. In one embodiment, the UE receives pre-configuration for the LTM, configures a second protocol stack based on the pre-configuration, configures a cell switch (CS) bearer upon receiving a cell switch command, wherein the CS bearer is associated to the source cell and the target cell. The UE performs the LTM handover based on the CS bearer. In one embodiment, the pre-configuration included multiple candidate cells and the UE configures the second protocol stack with multiple RLC entities. The MAC entity of the second protocol stack is a master cell group (MAC) MAC entity, which can be associated to multiple cells and multiple RLC entities.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2022/101936, titled “METHODS AND APPARATUS TO IMPROVE UE EXPERIENCE WITH A NEW TYPE OF RADIO BEARER DURING INTER-DU INTER-CELL BEAM MANAGEMENT,” with an international filing date of Jun. 28, 2022. This application claims priority under 35 U.S.C. § 119 from Chinese Application Number 202310693410.8, titled “METHODS AND APPARATUS TO IMPROVE UE EXPERIENCE WITH A NEW TYPE OF RADIO BEARER DURING INTER-DU INTER-CELL BEAM MANAGEMENT,” filed on Jun. 12, 2023. The disclosure of each of the foregoing documents is incorporated herein by reference.

### TECHNICAL FIELD

The disclosed embodiments relate generally to wireless communication, and, more particularly, to a new type of radio bearer during inter-DU inter-cell beam management.

### BACKGROUND

In conventional network of 3rd generation partnership project (3GPP) 5G new radio (NR), when the UE moves from the coverage area of one cell to another cell, at some point a serving cell change needs to be performed. Currently serving cell change is triggered by layer three (L3) measurements and is done by radio resource control (RRC) reconfiguration signaling with synchronization for change of primary cell (PCell) and primary and secondary cell (PSCell), as well as release/add for secondary cells (SCells) when applicable. The cell switch procedures involve complete L2 (and L1) resets, which causes longer latency, larger overhead and longer interruption time than beam switch mobility. To reduce the latency, overhead and interruption time during UE mobility, the mobility mechanism can be enhanced to enable a serving cell to change via beam management with L1/L2 signaling. The L1/L2 based inter-cell mobility with beam management should support the different scenarios, including intra-distributed unit (DU)/inter-DU inter-cell mobility change, FR1/FR2, intra-frequency/inter-frequency, and source and target cells may be synchronized or non-synchronized.

In legacy handover (HO) design controlled by a series of L3 procedures including radio resource management (RRM) measurement and RRC Reconfiguration, ping-pong effects should be avoided with relatively long ToS (time of stay) in order to reduce the occurrences of HOs, accompanied with which is the reduce of signaling overhead and interruption during the overall lifetime of RRC connection. However, the drawback is that UE cannot achieve the optimized instantaneous throughput if the best beam does not belong to the serving cell. With the development of L1/L2-based inter-cell mobility with beam management, the UE makes more decisions in preventing data loss during the cell switch. For the scenario of inter-DU handover, legacy handover procedure always triggers radio link control (RLC) re-establishment and medium access control (MAC) reset. All the packets in RLC and MAC which are not successfully delivered before handover execution are discarded. Since lossless data transmission should be guaranteed for acknowledged mode data radio bearers (AM DRBs), those PDCP PDUs which are not successfully delivered will be retransmitted after handover to target cell. For unacknowledged mode data radio bearers (UM DRBs), data loss is allowed during handover and the PDCP PDUs which are not successfully delivered will not be retransmitted after handover and considered as lost. However, for inter-DU inter-cell beam management with mobility, the existing frequent user plane (UP) handling method through RLC re-establishment and MAC reset will cause serious problems. Due to high ping-pong rate and short ToS, UP reset will result frequent data retransmission for AM DRBs and large number of data loss for UM DRBs, which will finally impair User experience.

Improvements and enhancements are required for inter-DU inter-cell beam management with mobility.

### SUMMARY

Apparatus and methods are provided for L1/L2-triggered mobility (LTM) cell switch. In one novel aspect, A UE which can be configured with more than one protocol stack performs a LTM handover. In one embodiment, the UE, configured with a first protocol stack, receives pre-configuration for the LTM, configures a second protocol stack based on the pre-configuration, configures a cell switch (CS) bearer upon receiving a cell switch command, wherein the CS bearer is associated to the source cell and the target cell. The UE performs the LTM handover/cell switch based on the CS bearer. In one embodiment, the pre-configuration included multiple candidate cells and the UE configures the second protocol stack with multiple RLC entities. The MAC entity of the second protocol stack is a master cell group (MCG) MAC entity, which can be associated to multiple cells and multiple RLC entities. In one embodiment, the LTM handover procedure resets a first MAC entity of the first protocol stack. In one embodiment, the LTM handover procedure establishes an RLC entity associated to the target cell for the second protocol stack and establishes a second MAC entity of the second protocol stack upon receiving the cell switch command for the target cell. In another embodiment, the LTM handover procedure actives the second protocol stack associated to the target cell upon success of the LTM handover procedure and keeps a first protocol stack to be associated to the source cell. In one embodiment, the LTM procedure keeps a time alignment timer associated to source cell running after switches to the target cell. In one embodiment, the source protocol stack is released and is triggered by receiving an RRC message from the network. In another embodiment, the source protocol stack is released when a source releasing timer expires. The source releasing timer is started when the UE switches to a target cell. The source releasing timer is stopped when the UE switches back to the source cell. The source protocol stack/source cell is released when the source releasing timer expires.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A is a schematic system diagram illustrating an exemplary wireless network for inter-DU inter-cell cell switch with LTM handover in accordance with embodiments of the current invention.

FIG. 1B illustrates handover failure (HOF) of legacy HO and L1/L2 based inter-cell mobility with beam management.

FIG. 10 illustrates Ping-pong of legacy HO and L1/L2 based inter-cell mobility with beam management.

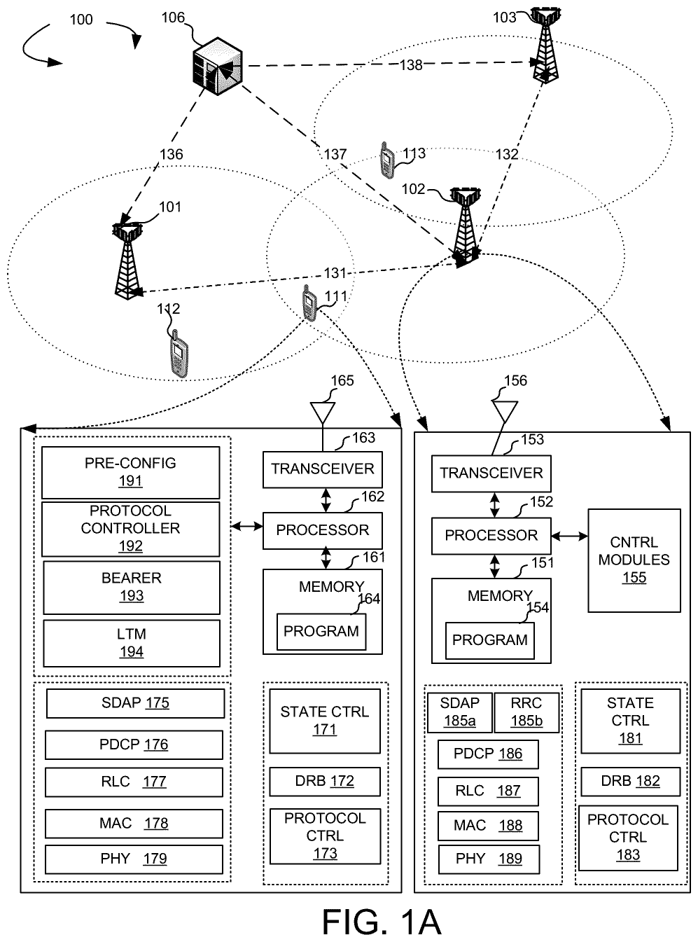

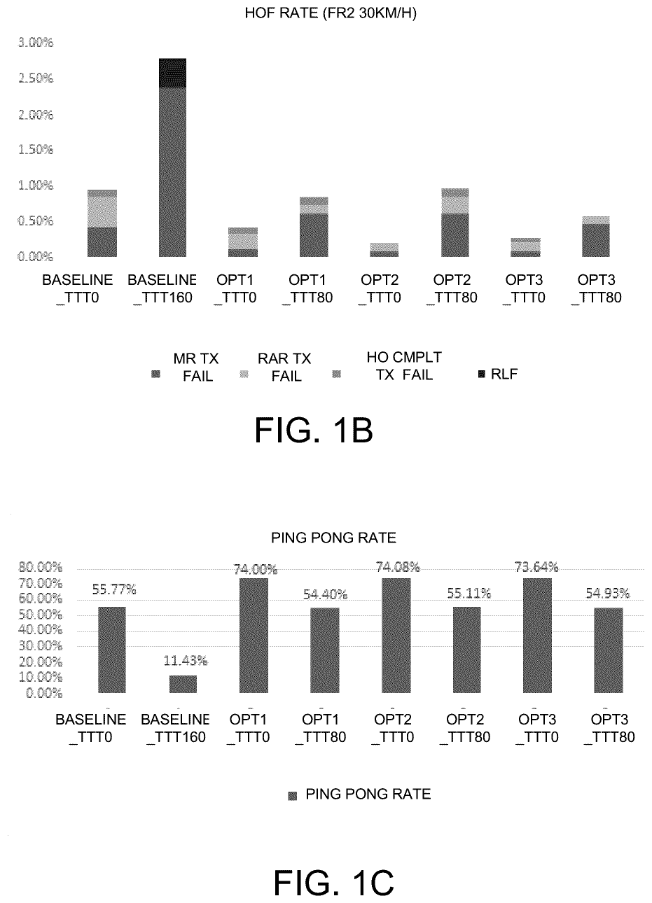

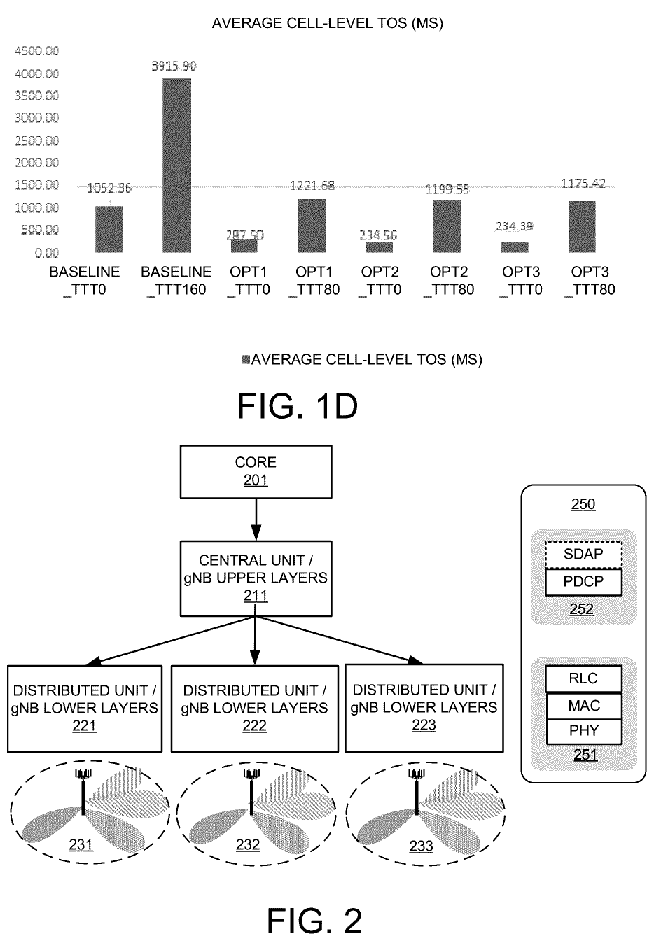

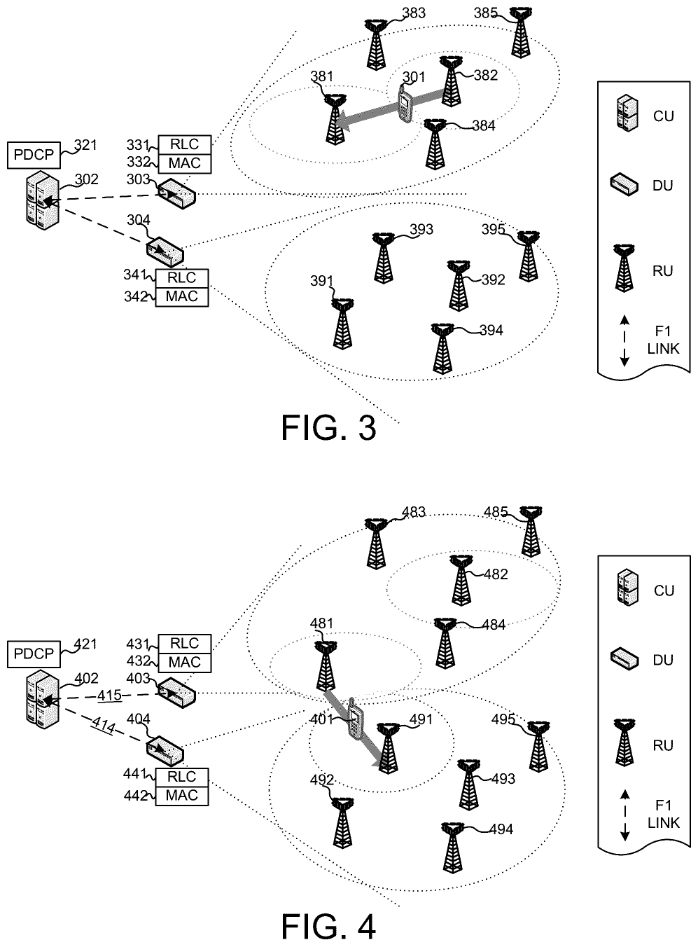

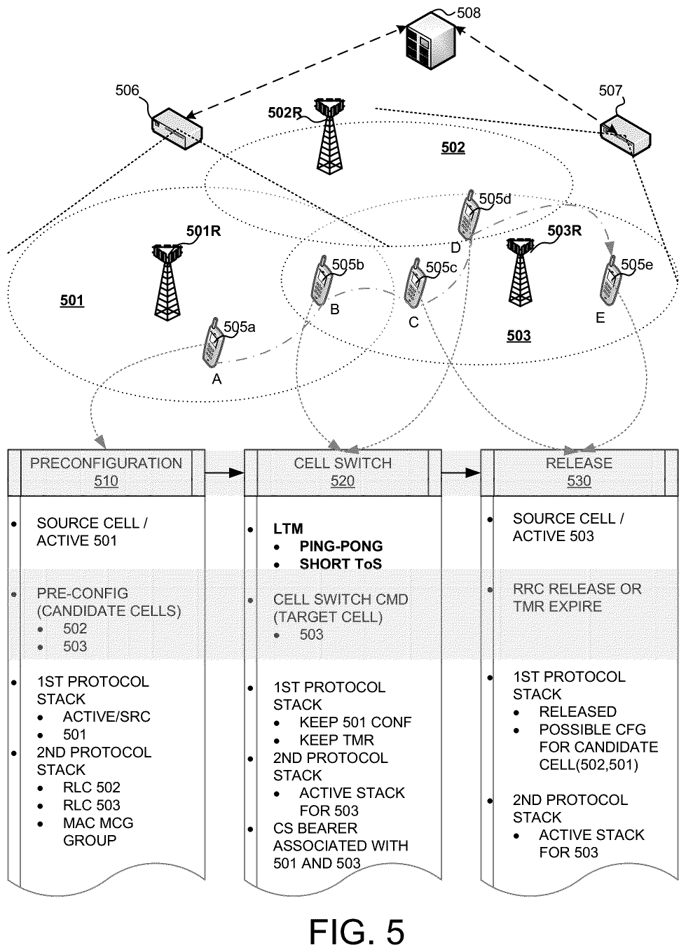

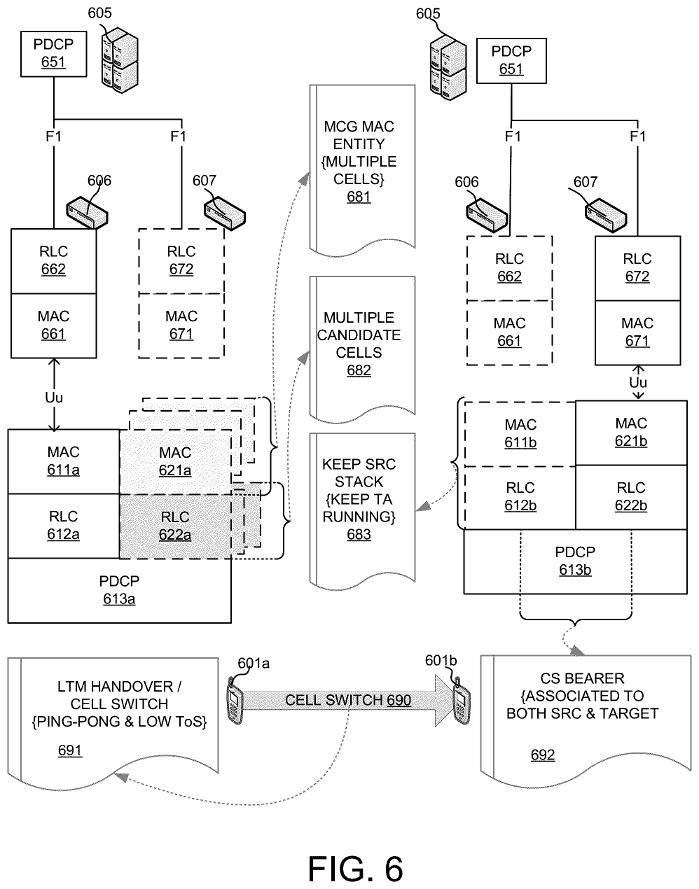

FIG. 1D illustrates time to stay (ToS) of legacy HO and L1/L2 based inter-cell mobility with beam management.

FIG. 2 illustrates an exemplary NR wireless system with centralized upper layers of the NR radio interface stacks in accordance with embodiments of the current invention.

FIG. 3 illustrates an exemplary deployment scenario for intra-DU inter-cell beam management in accordance with embodiments of the current invention.

FIG. 4 illustrates an exemplary deployment scenario for inter-DU inter-cell beam management in accordance with embodiments of the current invention.

FIG. 5 illustrates exemplary diagrams to use the CS bearer for inter-DU inter-cell beam management and cell switch with LTM in accordance with embodiments of the current invention.

FIG. 6 illustrates exemplary diagrams for cell switch with LTM with one active UE protocol stack in accordance with embodiments of the current invention.

FIG. 7 illustrates exemplary diagrams for cell switch with LTM with dual active UE protocol stack in accordance with embodiments of the current invention.

FIG. 8 illustrates exemplary diagrams for the UE to perform LTM handover and source release in accordance with embodiments of the current invention.

FIG. 9 illustrates an exemplary flow chart for the UE to perform LTM handover in accordance with embodiments of the current invention.

### DETAILED DESCRIPTION

Reference will now be made in detail to some embodiments of the invention, examples of which are illustrated in the accompanying drawings.

FIG. 1A is a schematic system diagram illustrating an exemplary wireless network for inter-DU inter-cell beam management in accordance with embodiments of the current invention. Wireless system 100 includes one or more fixed base infrastructure units forming a network distributed over a geographical region. As an example, base stations/gNBs 101, 102, and 103 serve a number of mobile stations, such as UE 111, 112, and 113, within a serving area, for example, a cell, or within a cell sector. In some systems, one or more base stations are coupled to a controller forming an access network that is coupled to one or more core networks, through a network entity, such as network entity 106. gNB 101, gNB 102 and gNB 103 are base stations in NR, the serving area of which may or may not overlap with each other. As an example, UE or mobile station 112 is only in the service area of gNB 101 and connected with gNB 101. UE 112 is connected with gNB 101 only. UE 111 in the overlapping service area of gNB 101 and gNB 102 and may switch back and forth between gNB 101 and gNB 102. UE 113 in the overlapping service area of gNB 102 and gNB 103 and may switch back and forth between gNB 102 and gNB 103. Base stations, such as gNB 101, 102, and 103 are connected the network through network entities, such as network entity 106 through NG connections, such as 136, 137, and 138, respectively. Xn connections 131 and 132 connect the non-co-located receiving base units. Xn connection 131 connects gNB 101 and gNB 102. Xn connection 132 connects gNB 102 and gNB 103. These Xn/NG connections can be either ideal or non-ideal.

When the UE, such as UE 111, is in the overlapping area, L1/L2-based inter-cell mobility is performed. For L1/L2 based inter-cell mobility with beam management, also known as the layer-2 triggered mobility (LTM) handover, the network can take advantage of ping-pong effects, i.e., cell switch back and forth between the source and target cells, to select the best beams among a wider area including both the source cell and target cell for throughput boosting during UE mobility. L1/L2 based inter-cell mobility is more proper for the scenarios of intra-DU and inter-DU cell change. The LTM handover selects and uses the best beam with high channel quality and takes advantage of the frequent cell switch and fast application by the short ToS for LTM handover. Ping-pong effect is not concerned in those scenarios. For intra-DU cell change, there is no additional signaling/latency needed at the network side. For inter-DU cell change, the F1 interface between DU and CU can support high data rate with short latency. L1/L2 based inter-cell mobility is supportable considering the F1 latency is 5 ms. In one embodiment, multiple candidate cells are preconfigured for the UE. The UE with an active first protocol stack, configures a second protocol stack for the one more candidate cells based on the pre-configuration. The LTM with pre-configuration of protocol stacks allows fast application of configuration for candidate cells and enables the UE with dynamic switches among candidate cells based on the L1/L2 signaling.

FIG. 1A further illustrates simplified block diagrams of a base station and a mobile device/UE for inter-DU inter-cell cell switch with LTM handover. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations. An RRC state controller 181 performs access control for the UE. A DRB controller 182 performs control function to establish/add, reconfigure/modify, and release/remove a DRB based on different sets of conditions for DRB establishment, reconfiguration and release. A protocol stack controller 183 manages to add, modify or remove the protocol stack for the DRB. The protocol Stack includes PHY layer 189, MAC layer 188, RLC layer 187, PDCP layer 186 and SDAP layer 185a for the user plane and an RRC layer 185b for the control plane.

UE 111 has antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown) for different frequency bands transmitting and receiving, which is different from the HF transceiver. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from antenna 156 of gNB 102.

UE 111 also includes a set of control modules that carry out functional tasks. These control modules can be implemented by circuits, software, firmware, or a combination of them. A pre-configuration module 191 receives a pre-configuration for multiple candidate cells in a wireless network, wherein the UE is connected with a first distributed unit (DU) of a source cell through a first protocol stack. A protocol controller 192 receives a pre-configuration for multiple candidate cells in a wireless network, wherein the UE is connected with a first distributed unit (DU) of a source cell through a first protocol stack. A bearer module 193 configures a cell switch (CS) bearer upon receiving a cell switch command to a target cell, wherein the CS bearer is associated to the source cell and the target cell. An L2 triggered mobility (LTM) module 194 performs an LTM handover procedure to the target cell.

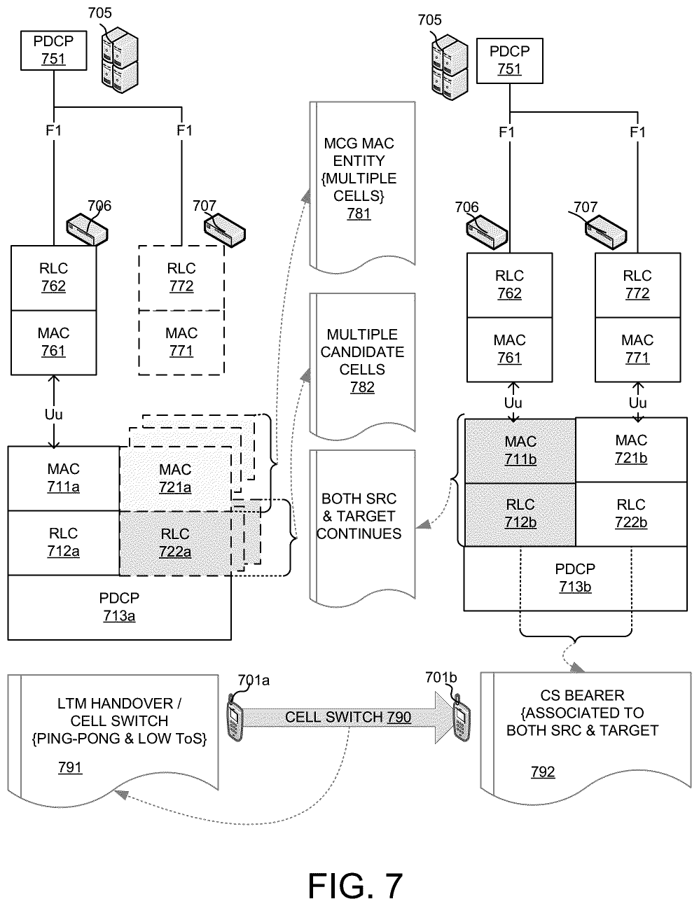

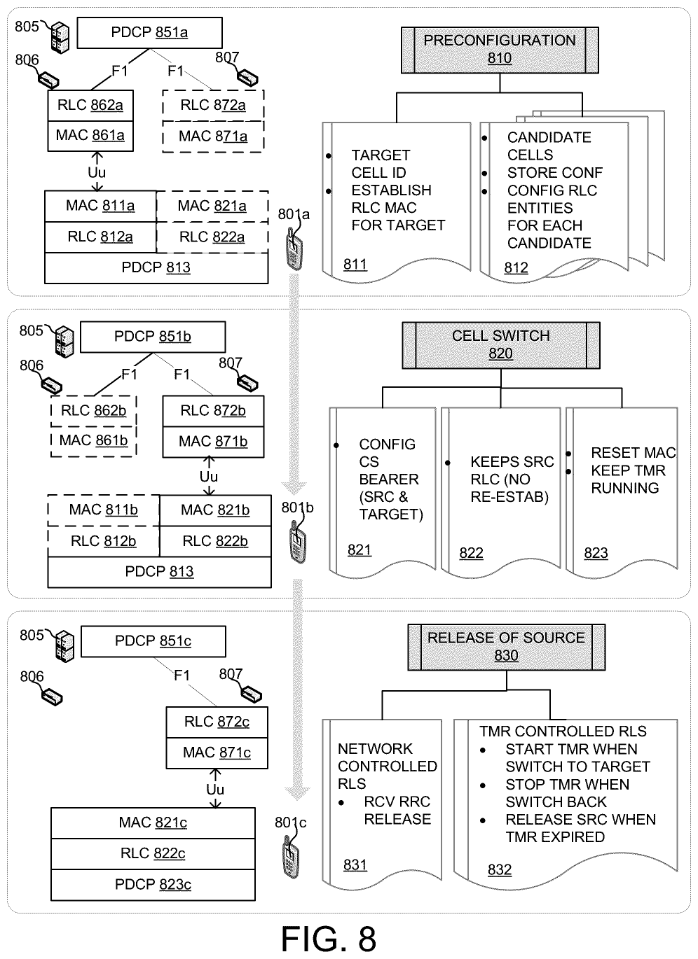

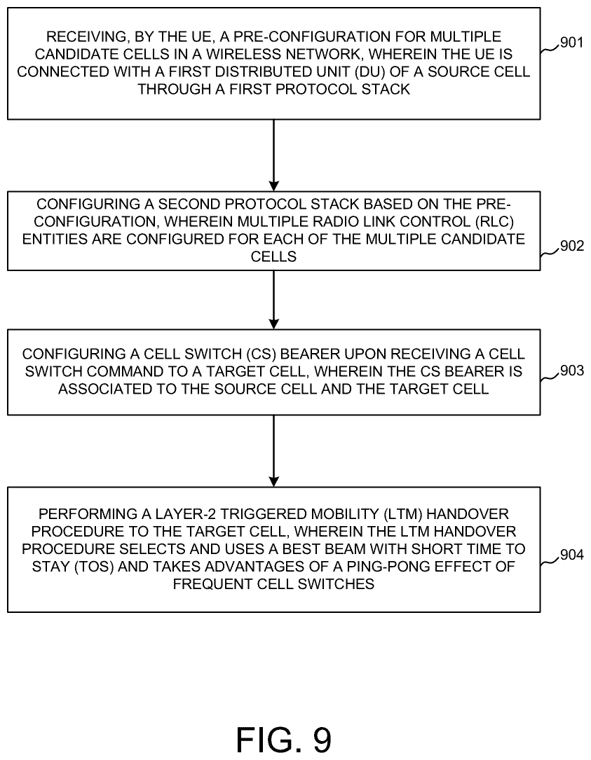

For the scenario of inter-DU handover, legacy handover procedure always triggers RLC re-establishment and MAC reset. All the packets in RLC and MAC which are not successfully delivered before handover execution are discarded. Since lossless data transmission should be guaranteed for AM DRBs, those PDCP PDUs which are not successfully delivered will be retransmitted after handover to target cell. For UM DRBs, data loss is allowed during handover and the PDCP PDUs which are not successfully delivered will not be retransmitted after handover and considered as lost. However, for inter-DU inter-cell beam management with mobility, the existing user plane (UP) handling method through RLC re-establishment and MAC reset will cause serious problems. Due to high ping-pong rate and short time of stay (ToS), frequency user plane (UP) reset will result in frequent data retransmission for AM DRBs and large number of data loss for UM DRBs, which will finally impair user experience. FIGS. 1B, 10 and 1D provides performance data to illustrate the ping pong effect and ToS under different settings.

We run system level simulation to compare the mobility performance in terms of handover failure (HOF) rate, radio link failure (RLF) rate, handover interruption time (HIT), Ping Pong rate and/or ToS. FIG. 1B illustrates HOF rate of legacy HO and L1/L2 based inter-cell mobility with beam management. The HOF may include measurement report (MR) TX fail, random access response (RAR) RX fail, HO complete TX fail and RLF. Option #1, #2, #3 are different options for L1/L2 based inter-cell mobility with beam management, which have different latency to perform handover or cell switch from the source cell to the target cell. The cell switch latency of option #1, #2 and #3 is 45 ms, 25 ms and 5 ms, respectively. The baseline is the normal handover procedure under time to trigger of 0 ms (TTT0/TTT=0 ms) or 160 ms (TTT160/TTT=160 ms), which is performed through a sequence of L3 procedures. The handover latency is 75 ms in the typical case in FR2. In FIG. 1B, it can be observed that HOF rate can be reduced dramatically by L1/L2 based inter-cell mobility with beam management under TTT0 or TTT80(TTT=80 ms). The shorter the latency, the better of HOF rate.

FIG. 10 illustrates ping-pong rate of legacy HO and L1/L2 based inter-cell mobility with beam management. The L1/L2 based inter-cell mobility with beam management can result in high ping-pong rate. The baseline is the normal handover procedure under TTT0 or TTT160. As shown the ping-pong rate increases from 55.77% in legacy handover to 74% with beam management. The consequence of the high ping-pong rate is the short ToS.

FIG. 1D illustrates ToS of legacy HO and L1/L2 based inter-cell mobility with beam management. The baseline is the normal handover procedure under TTT0 or TTT160. The average ToS can be reduced to about 200 ms in the L1/L2 based inter-cell mobility with beam management. For the mechanism of L1/L2 based inter-cell mobility with beam management, the network can take advantage of ping-pong effects, i.e., cell switch back and forth between the source and target cells, to select the best beams among a wider area including both the source cell and target cell for throughput boosting during UE mobility. L1/L2 based inter-cell mobility is more proper for the scenarios of intra-DU and inter-DU cell changes. Ping-pong effect is not concerned in those scenarios. For intra-DU cell change, there is no additional signalling/latency needed at the network side. For inter-DU cell change, the F1 interface between DU and CU can support high data rate with short latency. L1/L2 based inter-cell mobility is supportable considering the F1 latency is 5 ms.

With the illustrated new characteristics of the cell switch, especially for inter-DU cases, with beam management (as shown in FIGS. 1B, 1C and 1D), the legacy ways of triggering RLC re-establishment and MAC reset requires improvement. In one novel aspect, a new type of radio bearer is used for LTM handover to handle inter-DU inter-cell beam management, during which cell switch from the source cell to the target cell occurs. The new type of radio bearer is called ‘cell switch bearer’ (CS bearer). In one embodiment, the radio bearer is associated with RLC bearers both in source cell/DU and target cell/DU. The radio bearer has two RLC bearers. One RLC bearer is associated to the source cell/DU and the other RLC bearer is associated to the target cell/DU. Accordingly, in one embodiment, each MAC entity is considered as MCG (master cell group) MAC entity. Each MCG entity can be configured with multiple cells and multiple RLC bearers. The RLC entities/bearers and MAC entity is activated when the UE is served by the associated cell.

FIG. 2 illustrates an exemplary NR wireless system with centralized upper layers of the NR radio interface protocol stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221. Distributed units 221, 222, and 223 each correspond to a cell 231, 232, and 233, respectively. The DUs, such as 221, 222 and 223 include gNB lower layers 251. In one embodiment 250, gNB lower layers 251 include the PHY, MAC and the RLC layers.

FIG. 3 illustrates an exemplary deployment scenario for intra-DU inter-cell beam management in accordance with embodiments of the current invention. A CU 302 is connected to two DUs 303 and 304 through the F1 interface. CU 302 includes protocol stack PDCP 321. DU 303 includes protocol stack RLC 331 and MAC 332. DU 304 includes protocol stack RLC 341 and MAC 342. DU 303 and DU 304 are connected to multiple radio units (RUs) respectively. A cell may consist of a range covered by one or more RUs under the same DU. RUs/gNBs 381, 382, 383, 384, and 385 are connected with DU 303. RUs/gNBs 391, 392, 393, 394, and 395 are connected with DU 304. In this scenario, a UE 301 is moving from the edge of one cell served by gNB 382 to another cell served by gNB 381, which two belong to the same DU and share a common protocol stack. Intra-DU inter-cell beam management can be used in this scenario to replace the legacy handover process to reduce the interruption and improve the throughput of UE. In one novel aspect, LTM handover is performed with CS bearer. The LTM handover selects and uses the best beam with short ToS and takes advantage of a ping-pong effect of frequent cell switches.

FIG. 4 illustrates an exemplary deployment scenario for inter-DU inter-cell beam management in accordance with embodiments of the current invention. A CU 402 is connected to two DUs, DU 403 and DU 404 through the F1 interface, respectively. CU 402 includes protocol stack PDCP 421. DU 403 includes protocol stack RLC 431 and MAC 432. DU 404 includes protocol stack RLC 441 and MAC 442. DU 403 and DU 404 are connected to multiple RUs respectively. A cell may consist of a range covered by one or more RUs under the same DU. RUs/gNBs 481, 482, 483, 484, and 485 are connected with DU 403. RUs/gNBs 491, 492, 493, 494, and 495 are connected with DU 404. In this scenario, a UE 401 is moving from the edge of one cell served by gNB 481 to another cell served by gNB 491, which belong to different DUs, DU 403 and DU 404, respectively, and share a common CU 402. The low layer user plane (RLC, MAC) is different in two DUs while high layer (PDCP) remains the same. Inter-DU inter-cell beam management can be used in this scenario to replace the legacy handover process to reduce the interruption and improve the throughput of UE. The F1 interfaces 415 and 414 are established between CU 402 and DU 403, and between CU 402 and DU 404, respectively. The F1 interfaces 414 and 415 can support high data rate with short latency, which enable the LTM handover to be performed efficiently. In one novel aspect, the inter-DU cell switch is performed with LTM handover, which selects and uses the best beam with short ToS and takes advantages of a ping-pong effect of frequent cell switches.

FIG. 5 illustrates exemplary diagrams to use the CS bearer for inter-DU inter-cell beam management and cell switch with LTM in accordance with embodiments of the current invention. Three exemplary RU 501R, 502R, and 503R are deployed each serving a cell, cell 501, 502, and 503, respectively. As an example, RU 501R is served by DU 506, and RU 502R and 503R are served by DU 507. DU 506 and 507 are connected to CU 508 through F1 interfaces. As the UE moves around in the areas of cells 501, 502, and 503, LTM handover are performed for intra-DU and inter-DU intra-CU handover. In the example, UE moves with the trajectory A, B, C, D, E, and represented by UE 505a, 505b, 505c, 505d, 505e separately. At point A, UE 505a is served by the current serving cell 501 and approaching to the serving cell edge. At step 510, the UE receives the pre-configuration for the target cell or multiple candidate cells. UE 505a is activated with a first protocol stack with cell 501. UE 505a receives pre-configuration for candidate cells 502 and 503. In one novel aspect, the UE configures a second protocol stack for the candidate cells. In one embodiment, the MAC entities of UE protocol stacks, including the first and the second protocol stack, are master cell group (MCG) entities and can associate with multiple cells, such as cells 502 and 503. Multiple RLC entities are created for the candidate cells 502 and 503. At point B, UE moves to the edge of the serving cell. At step 520, UE 505b receives the cell switch command and is switched to the target cell, such as cell 503. Since the protocol for the target cell is prepared when receiving the pre-configuration message, UE is switched to the target cell directly. In one embodiment, the CS bearer is configured to associate to both cell 501 and 503. Considering the high ping-pong rate during cell switch through inter-cell beam management, which means UE may be switched back and forth between the source cell and the target cell. The CS bearer with both cell 501 and 503 enables efficient cell switch and enables the UE to always selects the best beam/cell through LTM handover, which takes advantage of ping-pong effect. The protocol of the source cell is kept when UE is switched to the target cell. When UE is switched back to the source cell, the protocol of the source cell can be used directly. By keeping the protocol of the source cell, cell switch can be performed with low latency. At point C, UE 505c moves away from the source cell 501 and is served by the target cell 503. At step 530, the source cell is released. Meanwhile, the protocol of the source cell is released. In one embodiment, the source cell is released upon detecting one or more releasing conditions. In one embodiment, the release condition is receiving a RRC message indicating to release the source cell. In another embodiment, a release timer is started when the target cell protocol stack, such as protocol stack for 503, is activated. If the UE switches back to cell 501, the timer is stopped. The timer is started when the UE switches away from cell 501. Upon the expiration of the timer, the UE releases the source protocol stack, such as protocol stack for cell 501. As UE moves further, at point D, UE 505d similarly, receives pre-configuration with one or more candidate cells, such as cell 502 and 503. The current active cell for 505c is cell 503 with a source protocol stack. The UE configures the other protocol stack to be associated to the one or more candidate cells as in step 520. At point D, UE 505d may switch to cell 502 through intra-DU LTM handover. As UE moves along, at point E, UE 505e releases protocol stack for cell 502 similarly as in step 530. The UE performs LTM handover/cell switch with CS bearer created, which is associated to both cell 503 and 502. The CS bearer enables the UE to perform intra-DU LTM handover efficiently.

FIG. 6 illustrates exemplary diagrams for cell switch with LTM with one active UE protocol stack in accordance with embodiments of the current invention. A UE at source cell is configured with source protocol stack of MAC 611a, RLC 612a and PDCP 613a. Source cell has a DU 606 with MAC 661 and RLC 662. Candidate Cell/target cell DU 607 has MAC 671 and RLC 672. DU 606 and DU 607 are connected to CU 605 with PDCP 651. In one embodiment, UE 601a and UE 601b represents the same UE which moves to different location. When UE 601a receives pre-configuration, the UE further configured to be associated with multiple candidate cells in the pre-configuration. Based on the pre-configuration, UE 601a is preconfigured with a second protocol stack of MAC 621a, RLC 622a, and PDCP 613a. In one embodiment 681, each MAC entity is considered as MCG (master cell group) MAC entity. Each MCG entity can be configured with multiple cells and multiple RLC bearers. In one embodiment 682, each candidate cell is associated to a corresponding RLC entity. The RLC entities/bearers and MAC entity is activated when the UE is served by the associated cell. The RLC and MAC entities are associated to the common PDCP 613a.

In one novel aspect 691, LTM handover/cell switch 690 is performed when the UE is at the cell edge. The LTM handover/cell switch selects the best beam/candidate cell and performs cell switch taking advantage of the ping-pong effect. Upon receiving the cell switch command to a target cell, UE 601b activates the target cell with protocol stack of MAC 621b, RLC 622b, and PDCP 613b corresponding to target DU 607 stack of RLC 672 and MAC 671. The source DU 606 with RLC 662 and 661 stops transmission to UE 601b. In one embodiment 683, the source protocol stack with MAC 611b, RLC 612b and PDCP 613b are not released. In one embodiment, the time alignment timer for the source cell keeps running. In one embodiment 692, the CS bearer is configured to be associated to both the source cell and the target cell with corresponding protocol stacks. In one embodiment, even if two protocol stacks are configured for each CS bearer, only one protocol stack is activated in use. As illustrated, protocol stack of MAC 621b and RLC 622b are active and MAC 611b and RLC 612b are deactivated.

FIG. 7 illustrates exemplary diagrams for cell switch with LTM with dual active UE protocol stack in accordance with embodiments of the current invention. A UE at source cell is configured with source protocol stack of MAC 711a, RLC 712a and PDCP 713a. Source cell has a DU 706 with MAC 761 and RLC 762. Candidate Cell/target cell DU 707 has MAC 671 and RLC 772. Target cell has a DU 707 with MAC 771a and RLC 772a. DU 706 and DU 707 are connected to CU 705 with PDCP 751. In one embodiment, UE 701a and UE 701b represents the same UE which moves to different location. when UE 701a receives pre-configuration, the UE further configured to be associated with multiple candidate cells in the pre-configuration. Based on the pre-configuration, UE 701a is preconfigured with a second protocol stack of MAC 721a, RLC 722a, and PDCP 713a. In one embodiment 781, each MAC entity is considered as MCG MAC entity. In one embodiment 782, each candidate cell is associated to a corresponding RLC entity.

In one novel aspect 791, LTM handover/cell switch 790 is performed when the UE is at the cell edge. The LTM handover/cell switch selects the best beam/candidate cell and performs cell switch taking advantage of the ping-pong effect. Upon receiving the cell switch command to a target cell, UE 701b activates the target cell with protocol stack of MAC 721b, RLC 722b, and PDCP 713b corresponding to target DU 707 protocol stack of RLC 772 and MAC 771. In one embodiment, the source DU 706 with RLC 762 and 761 continues transmission to UE 701b. In one embodiment 783, the source protocol stack with MAC 711b, RLC 712b and PDCP 713b continues to transceiving with UE 701b. In one embodiment, the time alignment timer for the source cell keeps running. In one embodiment 792, the CS bearer is configured to be associated to both the source cell and the target cell with corresponding protocol stacks. The UE is served by both the source cell and the target cell. The two protocols are both activated and in use. As illustrated, both protocol stack of MAC 721b and RLC 722b and MAC 711b and RLC 712b are active.

FIG. 8 illustrates exemplary diagrams for the UE to perform LTM handover and source release in accordance with embodiments of the current invention. In FIG. 8, UE 801a, UE 801b and UE 801c represents the same UE which moves to different locations. At step 810, UE 801a receives pre-configuration message from network. UE 801a has a first stack with MAC 811a, RLC 812a and PDCP 813, and a second UE stack with MAC 821a, RLC 822a and PDCP 813. Source DU 806 with RLC 862a and MAC 861a connects with PDCP 851a of CU 805. An exemplary candidate or target DU 807 with RLC 872a and MAC 871a is connected with PDCP 851a of CU 805. In one embodiment 811, the pre-configuration contains the target cell ID, cell group configuration with configuration for MAC, RLC and PHY and other configuration required for data transmission/reception with the target cell. In one embodiment, when UE receives the pre-configuration message, it processes the RRC message and stores the configuration information for the target cell or candidate cells. In one embodiment, UE establishes the RLC entity and create MAC entity for the target cell. In another embodiment 812, UE receives the pre-configuration for multiple candidate cells. For each candidate cell, the candidate cell ID, cell group configuration with configuration for MAC, RLC and PHY and other configuration required for data transmission/reception with the candidate cell are provided. UE associates the RLC entity with the common PDCP. In another embodiment when multiple candidate cells are pre-configured, UE establishes the RLC entity and create MAC entity for each candidate cell. In another embodiment when multiple candidate cells are pre-configured, UE establishes the RLC entity for each candidate cell.

When UE moves towards the target cell, at some point of time, at step 820, the UE receives a cell switch command. The UE reconfigures the protocol stack. UE 801b has a first stack with MAC 811b, RLC 812b and PDCP 813 and a second UE stack with MAC 821b, RLC 822b and PDCP 813. The second UE stack is to be configured to associate with target DU 807. Source DU 806 with RLC 862b and MAC 861b connects with PDCP 851b of CU 805. Target DU 807 with RLC 872b and MAC 871b are connected to PDCP 851b of CU 805. In one embodiment 821, the UE configures the CS bearer to be associated to both the target and the source cell. In one embodiment, when UE switches to the target cell, the RLC entities/bearers associated to the source cell are re-established. In another embodiment, when UE switches to the target cell, the RLC entities/bearers associated to the source cell are kept as they are without re-establishment. In one embodiment, when UE switches to the target cell, UE creates MAC entity for the target cell if there is no MAC entity associated to the target cell when the cell switch command is received. In one embodiment, UE reset the MAC entity for the source cell. In this case, the time alignment timer for the source cell keeps running and is not stopped when the MAC entity for the source cell is reset.

When UE moves away from the source cell and is served by the target cell, at step 830, the source cell is released. UE 801c has a second stack with MAC 821c, RLC 822c and PDCP 813. The first UE stack associated with source DU 806 is released. Source DU 806 releases the connection with UE 801c. Target DU 807 with RLC 872c and MAC 871c connects to PDCP 851c of CU 805. UE releases RLC entity/RLC bearers associated to the source cell. In one embodiment, UE resets the MAC entity associated to the source cell. In one embodiment, the source cell release is controlled by the network. UE receives the RRC message to release source cell. In another embodiment, the source cell release is controlled implicitly by a timer. The timer is configured per cell and controlled by the associated MAC entity. When UE receives the cell switch command and performs cell switch to the target cell, UE starts the timer for the source cell. When UE receives the cell switch command to switch back to the source cell, UE stops the timer. When the timer expires, UE releases the source cell.

FIG. 9 illustrates an exemplary flow chart for the UE to perform LTM handover in accordance with embodiments of the current invention. At step 901, the UE receives a pre-configuration for multiple candidate cells in a wireless network, wherein the UE is connected with a first distributed unit (DU) of a source cell through a first protocol stack. At step 902, the UE configures a second protocol stack based on the pre-configuration, wherein multiple radio link control (RLC) entities are configured for each of the multiple candidate cells. At step 903, the UE configures a cell switch (CS) bearer upon receiving a cell switch command to a target cell, wherein the CS bearer is associated to the source cell and the target cell. At step 904, the UE performs a layer-2 triggered mobility (LTM) handover procedure to the target cell.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE), comprising:
receiving, by the UE, a pre-configuration for multiple candidate cells in a wireless network, wherein the UE is connected with a first distributed unit (DU) of a source cell through a first protocol stack;
configuring a second protocol stack based on the pre-configuration, wherein multiple radio link control (RLC) entities are configured for each of the multiple candidate cells;
configuring a cell switch (CS) bearer upon receiving a cell switch command to a target cell, wherein the CS bearer is associated to the source cell and the target cell; and
performing a layer-2 triggered mobility (LTM) handover procedure to the target cell.

2. The method of claim 1, wherein the target cell is served by the first DU.

3. The method of claim 1, wherein the target cell is served by a second DU with a same central unit (CU) as the first DU.

4. The method of claim 1, wherein a second MAC entity of the second protocol stack is a master cell group (MCG) MAC entity associated to the multiple RLC entities of the multiple candidate cells.

5. The method of claim 1, wherein the LTM handover procedure establishes an RLC entity associated to the target cell for the second protocol stack upon receiving the cell switch command.

6. The method of claim 5, wherein the LTM handover procedure establishes a second MAC entity of the second protocol stack for the target cell upon receiving the cell switch command.

7. The method of claim 1, wherein the LTM handover procedure actives the second protocol stack associated to the target cell upon success of the LTM handover procedure and keeps the first protocol stack to be associated to the source cell.

8. The method of claim 7, wherein the LTM handover procedure resets a first MAC entity of the first protocol stack.

9. The method of claim 8, wherein the LTM procedure keeps a time alignment timer associated to source cell running.

10. The method of claim 1, wherein the LTM handover procedure releases the first protocol stack of the source cell upon detecting one or more predefined releasing conditions.

11. The method of claim 10, wherein the releasing condition is receiving an RRC message from the wireless network.

12. The method of claim 10, wherein the releasing condition is an expiration of a source timer.

13. The method of claim 12, wherein the source timer is configured for each cell and controlled by an associated MAC entity.

14. The method of claim 12, wherein the source timer is started when the UE switches to the target cell and is stopped when the UE switches back to the source cell.

15. A user equipment (UE), comprising:
a transceiver that transmits and receives radio frequency (RF) signal in a wireless network;
a pre-configuration module that receives a pre-configuration for multiple candidate cells in a wireless network, wherein the UE is connected with a first distributed unit (DU) of a source cell through a first protocol stack;
a protocol controller that configures a second protocol stack based on the pre-configuration, wherein multiple radio link control (RLC) entities are configured for each of the multiple candidate cells;
a bearer module that configures a cell switch (CS) bearer upon receiving a cell switch command to a target cell, wherein the CS bearer is associated to the source cell and the target cell; and
a layer-2 triggered mobility (LTM) module that performs an LTM handover procedure to the target cell.

16. The UE of claim 15, wherein the target cell is served by the first DU or is served by a second DU with a same central unit (CU) as the first DU.

17. The UE of claim 15, wherein a second MAC entity of the second protocol stack is a master cell group (MCG) MAC entity associated to the multiple RLC entities of the multiple candidate cells.

18. The UE of claim 15, wherein the LTM handover procedure establishes an RLC entity associated to the target cell and establishes a second MAC entity associated to the target cell for the second protocol stack upon receiving the cell switch command.

19. The UE of claim 15, wherein the LTM handover procedure actives the second protocol stack associated with the target cell upon success of the LTM handover procedure and keeps the first protocol stack to be associated with the source cell.

20. The UE of claim 15, wherein the LTM handover procedure resets a first MAC entity of the first protocol stack and keeps a time alignment timer associated with source cell running.
